(19) United States
(12) Patent Application Publication
(10) Pub. No.: US 2026/0061529 A1
(43) Pub. Date: Mar. 5, 2026

(54) HOLD-DOWN TOOL

(71) Applicant: Hesse GmbH, Paderborn (DE)

(72) Inventors: Sascha BISTRY, Paderborn (DE); Hans-Juergen HESSE, Paderborn (DE); Alexander KLINGEBIEL, Bielefeld (DE); Patrick VEHMEIER, Luegde-Hummersen (DE); Frank WALTHER, Paderborn (DE)

(73) Assignee: Hesse GmbH, Paderborn (DE)

(21) Appl. No.: 19/380,915

(22) Filed: Nov. 5, 2025

Related U.S. Application Data
(63) Continuation of application No. PCT/DE2024/100249, filed on Mar. 22, 2024.

(30) Foreign Application Priority Data
May 5, 2023 (DE) 10 2023 111 842.0

(51) Int. Cl. B23K 37/04; B23K 26/21

(52) U.S. Cl. CPC B23K 37/04; B23K 26/21

(57) ABSTRACT

A hold-down tool for a laser welding system. A tubular hollow body has a lateral surface that is designed to be closed in a laminar manner at least in some sections. A tool insert is formed as a contact element which is flexibly held on the hollow body and provides a tool contact surface for bringing the tool insert into contact with a first contact component to be welded.

This nonprovisional application is a continuation of International Application No. PCT/DE2024/100249, which was filed on Mar. 22, 2024, and which claims priority to German Patent Application No. 10 2023 111 842.0, which was filed in Germany on May 5, 2023, and which are both herein incorporated by reference.

### BACKGROUND OF THE INVENTION

### Field of the Invention

The invention relates to a hold-down tool for a laser welding system.

### Description of the Background Art

Classic laser welding systems have been used for many years to bond metallic contact components in particular. Today, however, these systems are only able to compensate for the shape and position tolerances of the contact components to a limited extent.

### SUMMARY OF THE INVENTION

It is therefore an object of the present invention is to provide an improved hold-down tool for a laser welding system.

To achieve the object, in an example, the invention has a hold-down tool for a laser welding system comprises a tubular hollow body which has a lateral surface that is designed to be in a laminar manner at least in sections, as well as a tool insert. The tool insert is flexibly held on the hollow body and, as a contact element of the hold-down tool, provides a tool contact surface for bringing the tool insert into contact with a first contact component to be welded.

The special advantage of the invention is that the laser beam for welding the contact components can be guided through the tubular hollow body to a connection point, and the hold-down tool with the tool insert can at the same time compensate for the shape and position tolerances of the contact components to be welded. The compensation of shape and position tolerances and, in particular, the flat pressing together of the contact components promotes the secure and error-free welding of these components. In addition, the contact of the tool insert, which is held flexibly with respect to the hollow body, on the contact component facing the hold-down tool, in particular the upper one to be welded, makes it possible to counteract contamination of the surrounding area during the production of the welded joint.

The hold-down tool with the tubular hollow body on the one hand and the tool insert held flexibly to the hollow body on the other hand therefore has a multiple function. It shields the laser beam so that a non-directional reflection of the laser beam, which is particularly critical from a safety point of view, is counteracted. In addition, by pressing the hold-down device against the upper contact component to be welded, the shape and position tolerances of the contact components can be compensated. The flexibility between the tool insert and the hollow body counteracts mechanical damage to the contact components to be joined. This is particularly important for sensitive electronic components. Finally, the hold-down tool with the tubular hollow body and the tool insert held in it flexibly shields the welded joint. Pollution of the surrounding area by, for example, spatters created during welding, is also counteracted.

The tool insert can be spring-mounted on the hollow body. It has advantageously been shown that the spring-mounted holder of the tool insert on the hollow body can be implemented both cost-effectively and robustly. In this respect, corresponding hold-down tools are durable and at the same time characterized by a high level of cost-effectiveness.

A pressure spring can be provided for spring-mounted support of the tool insert on the hollow body. The pressure spring is realized in particular as an internal pressure spring, which is surrounded by the hollow body and/or the tool insert. Advantageously, mechanical protection of the pressure spring from external influences is given by providing the internal pressure spring. Damage to the pressure spring is thus counteracted.

The tool insert can be designed in the form of hollow ball ring segments. In this respect, it has a ball ring segment lateral surface that can be brought into contact with a base surface provided by the hollow body and shaped corresponding to the ball ring segment lateral surface. In addition, the flexible or springy attachment of the tool insert to the hollow body is implemented in such a way that the tool insert is arranged in a pivotable manner relative to the hollow body. Advantageously, by providing the ball ring segment surface and the base surface as well as the pivoting attachment of the tool insert to the hollow body, the hold-down tool, which is typically movable in a vertical axis, can be brought into contact with the upper contact component to be welded, even if the latter is arranged at an angle to the horizontal. The ball ring segment lateral surface and the corresponding base surface of the hollow body ensure that the tool insert always lies flat against the hollow body. As a result, maximum stability and robustness is given, regardless of the pivot position.

The tool insert can be pivoted relative to the hollow body about a pivot point which is formed on the surface of the first contact component in a contact position in which the tool contact surface of the tool insert is in flat contact with a surface of the first contact component. This, together with the flexible and pivoting attachment of the tool insert to the hollow body of the hold-down tool, advantageously ensures that the hold-down tool can be brought flat against the upper contact component to be welded at an oblique angle, without causing a relative movement in the sense of rubbing or sliding between the hold-down tool or the hold-down tool insert of the hold-down tool which comprises the tool contact surface on the one hand, and the upper contact component on the other. By avoiding the relative movement, the mechanical stress on the surface of the contact components is reduced and damage to electronic components, for example, which are mounted on the surface of the contact component is counteracted.

The tool contact surface of the tool insert can be ring-shaped or flat. The ring-shaped tool contact surface, preferably closed and flat in the circumferential direction, ensures an even and distributed application of force when the hold-down tool is brought into contact with the upper contact component to be welded. In addition, there is improved shielding of the welded joint both in terms of the reflected laser beam and mechanical impurities, which can occur, for example, as a result of spatter released from the melt.

The tool insert can provide an attachment protruding from the hollow body, wherein the attachment provides the tool contact surface and thus faces the upper contact component to be welded. By providing the attachment that protrudes from the hollow body or stands out from it, the handling of the hold-down tool is improved. In particular, small, delicate joints can be approached or formed by providing the attachment. In this respect, the attachment forms a taper of the tool insert in the direction of the contact components.

The hollow body can be formed in several parts. It provides a lateral part that provides the ring lateral surface as well as a base part that provides the base surface for the tool insert. Optionally, a cap can also be provided, which also encloses the base part or the tool insert of the hold-down tool in sections. The multi-part nature of the hollow body results in advantages in terms of design and production technology. In particular, the base surface can be manufactured separately from the lateral part as part of the base part and the base part can be subsequently connected to the other parts of the hollow body.

The tool insert can be designed in several parts. For example, it provides an interchangeable body that provides the tool contact surface, which is held interchangeably on an mounting component of the tool insert. The multi-part tool insert with the interchangeable body providing the tool contact surface can advantageously offer considerable cost advantages during operation. With increasing wear, for example in the area of the tool contact surface, only the interchangeable body of the tool insert needs to be replaced, whereas the mounting component and also other components of the tool insert can continue to be used. In this respect, the interchangeable body can be designed as a cost-effective wear component.

The tool insert can provide an upper part, which provides the ball ring segment lateral surface. In contrast to the interchangeable body, for example, the upper part is preferably not designed as a wear component of the tool insert or hold-down device. There is then no need to regularly replace the upper part with the production-intensive ball ring segment lateral surface.

The upper part of the tool insert can serve as an mounting component for the interchangeable body. The tool insert can then provide, for example, two essential functional components, namely the upper part and the interchangeable body.

The interchangeable body can be fixed to the mounting component in a force-fit or form-fitting manner. In particular, a quick-release mechanism may be provided for fixing the interchangeable body to the mounting component. For example, a bayonet lock can be provided as a quick-release fastener for tool-free locking of the interchangeable body on the mounting component. For example, circulating grooves can be provided on the mounting component on the one hand and the interchangeable body on the other, into which a ring-shaped, elastic retaining spring is inserted. The retaining spring can be designed in such a flexible manner that the interchangeable body can be connected to the mounting component without tools by means of the retaining spring and fixed to it. The retaining spring, which engages in the circulating grooves, defines the relative position of the interchangeable body and the mounting component.

A laser channel through which the laser beam can be guided to the upper contact component to be welded can extend through the tubular hollow body and the tool insert. In particular, it may be provided that the laser channel extends through the lateral part and/or the base part of the hollow body as well as the upper part, the mounting component and/or the interchangeable body of the tool insert. A longitudinal center axis of the hold-down tool can run through the laser channel.

The hold-down tool can provide a gas channel which serves to guide a gas as purge gas, for example air or an inert shielding gas, preferably argon or nitrogen, to a working space formed at the tool insert which is adjacent to the upper contact component. The working space, which may be formed in the area of the attachment, for example, provides a gas outlet opening as the end of the gas channel. The gas channel itself preferably extends through the hollow body on the one hand, and the tool insert on the other.

The gas supplied over the gas channel to the working space can be discharged via the laser channel. For example, extraction of the gas via the laser channel may be provided.

For example, ambient air can enter the tool insert or working space through inlet openings provided at the tool insert. In particular, the ambient air can be sucked in via the inlet openings, while the gas supplied via the gas duct is extracted. An extraction device can therefore extract the gas supplied via the gas duct, the ambient air supplied to the inlet openings and/or the ambient air-gas mixture. The inlet openings are preferably provided above the outlet opening of the gas duct and/or the attachment, i.e., at a greater distance from the tool contact surface.

The tool insert or parts thereof, in particular the interchangeable body of the tool insert, can be formed of an electrically insulating material, at least in an area having the tool contact surface. Preferably, technical ceramics can be used as a material here.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic diagram of a laser welding arrangement with a hold-down tool with an ideally perpendicular orientation of a working plane to a longitudinal center axis of the hold-down tool and the extension of the contact components to be welded by laser in the working plane,

FIG. 2 shows an example of a hold-down tool with a hollow body and a tool insert in a perspective view obliquely from below,

FIG. 3 shows the hold-down tool in the example in a perspective view obliquely from above,

FIG. 4 shows a first longitudinal view of the hold-down tool in the example,

FIG. 5 shows a second longitudinal view of the hold-down tool in the example rotated by 90° to the first longitudinal view,

FIG. 6 shows a perspective top view of an upper part of the tool insert of the hold-down tool in the example,

FIG. 7 shows a perspective underside view of the upper part of the tool insert according to FIG. 6,

FIG. 8 shows a perspective top view of a base part of the hollow body of the hold-down tool facing the tool insert in the example,

FIG. 9 shows a perspective underside view of the base part of the hollow body according to FIG. 8,

FIG. 10 shows a first working position of the hold-down tool in the example when laser welding a first contact component oriented in the working plane,

FIG. 11 shows a second working position of the hold-down tool in the example when laser welding a first contact component oriented in the working plane,

FIG. 12 shows a first working position of the hold-down tool in the example when laser welding a first contact component oriented at an angle to the working plane and a second contact component extended in the working plane,

FIG. 13 shows a second working position of the hold-down tool in the example when laser welding the first contact component oriented at an angle to the working plane and the second contact component extended in the working plane,

FIG. 14 shows a third working position of the hold-down tool in the example when laser welding the first contact component oriented at an angle to the working plane and the second contact component extended in the working plane,

FIG. 15 shows a fourth working position of the hold-down tool in the example when laser welding the first contact component previously oriented at an angle to the working plane and the second contact component extended in the working plane,

FIG. 16 shows a first working position of the hold-down tool in the example when laser welding two contact components which are oriented at an angle to the working plane and spaced from each other,

FIG. 17 shows a second working position of the hold-down tool in the example when laser welding the two contact components which are oriented at an angle to the working plane and spaced from each other,

FIG. 18 shows a third working position of the hold-down tool in the example when laser welding the two contact components which are oriented at an angle to the working plane and were previously spaced from each other,

FIG. 19 shows a longitudinal cut through the hold-down tool in a second example with a tool insert in an assembly position,

FIG. 20 shows a longitudinal cut through the hold-down tool in a second example with a tool insert in a removal position,

FIG. 21 shows a perspective view of the hold-down tool in the second example with the tool insert in the assembly position,

FIG. 22 shows a perspective view of the hold-down tool in the second example with the tool insert in the removal position,

FIG. 23 shows a first longitudinal view of the hold-down tool in a third example, and

FIG. 24 shows a second longitudinal view of the hold-down tool rotated by 90° to the first longitudinal view.

### DETAILED DESCRIPTION

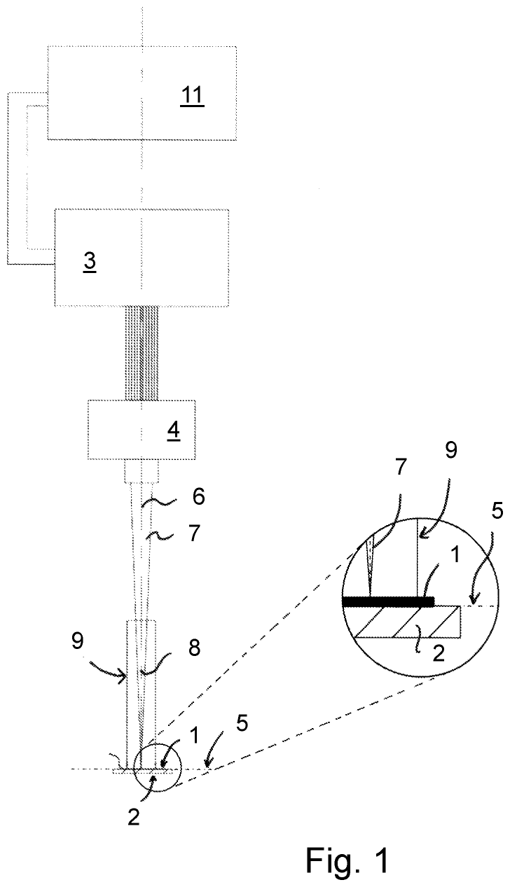

For the welding of metallic contact components 1, 2 in electrical engineering, battery technology and power electronics, laser welding systems with a laser source 3 as an energy source are used, among other things. A laser beam 7 provided by the laser source 3 is typically guided through an optical fiber to an optical unit 4, which is located above the working plane 5. The optical unit 4 is aligned in such a way that the symmetry axis 6 of the focused laser beam 7 runs collinear with a typically vertically extended symmetry or longitudinal center axis 8 of a hold-down tool 9 of the laser welding system and perpendicular to the working plane 5 (see FIG. 1).

Ideally, the contact components 1, 2 to be welded, or their contact surfaces, extend in the working plane 5 or are parallel to it. Contact surfaces of the contact components 1, 2 facing each other run parallel to each other. The hold-down tool 9 is then used to press the contact components 1, 2 on top of each other without gaps and to shield the welded joint. In particular, in the case of the preferred deep-welding, the contact components 1, 2 to be welded must be flush with each other. There must be no gap between the contact components 1, 2, otherwise a high-quality, low-spatter or spatter-free welding is not possible.

The contact points of the contact components 1, 2 to be connected can, if the topology allows it, be aligned in such a way that they are directly connected to each other. No additional lines (with round or rectangular cross-sections) are then necessary to create an electrically conductive connection.

If the number of contact points is large or if the contact points are spatially distributed, a direct connection of the contact points is not possible. Additional conductors are then required, which must be brought to the contact points and connected there to the contact points of the contact components 1, 2 by a suitable connection technology. In order not to have to bring the conductors individually to the respective contact points, it makes sense to combine the necessary connections in an additional contacting system, similar to a printed circuit board, which contains all the lines for connecting the individual components as a first contact component 1. Such contacting systems are used, for example, for the wiring or contacting of larger battery modules or other matrix-shaped contact components that are to be connected to the first contact component 1 as the second contact component 2. At the points where the contact points of the electrically contactable module are located, the contacting system has clearances from which a contact strip emerges and can be connected to the contact of the module.

The contacting system is, for example, designed cost-effectively as a sheet metal stamped part and is subject to tolerances or is not ideally flat. In addition, it can be seen in practice that, for example, the individual battery cells of a battery module are assigned to each other subject to tolerance. These tolerances must then also be compensated for in the course of the production of the welded joint.

In order to create the bonded welded joint of the contact components 1, 2, the hold-down tool 9 provides a laser channel 10 for the laser beam 7. The hold-down device 9 is in flat contact with a tool contact surface 53 facing away from the optical unit 4 to the first, upper contact component 1 facing the optical unit 4 and is dimensioned or positioned in such a way that the focused laser beam 7 passes through the laser channel 10 and strikes the first contact component 1 at the end face of the hold-down tool 9 facing away from the optical unit 4. The flat contact of the hold-down tool 9 with the upper, first contact component 1 and the lateral surface 26 of the hold-down tool 9, which is closed at least in sections, have a shielding effect and ensure that molten material does not spatter uncontrollably during welding. In this respect, the hold-down tool 9 prevents contamination of the surrounding area and counteracts a later malfunction due to the formation of damaged, unintentional, electrically conductive contacts.

The modules can contain contact points or surfaces of different heights. The hold-down tool 9 is firmly connected to an axis system of the laser welding system, which is movable in the vertical direction. In this respect, the hold-down tool 9 can reach contact points or contact surfaces at different heights. The orientation of the hold-down tool 9 is typically perpendicular to the working plane 5. In addition, it can be provided that the hold-down tool 9 is moved and positioned horizontally via suitable xy-kinematics of the laser welding system.

In this case, the optical unit 4 can be controlled by a controller 11 of the laser welding system and is set up to move the focused laser beam 7 along the contact components 1, 2 and to form a linear or flat welding.

In practice, it is often observed that the contact elements 1, 2 are not arranged in a straight line in the working plane 5 and/or do not extend parallel to each other. For example, due to their shape, contact elements 1, 2 may only touch each other at a few points and/or be arranged at an angle to the working plane 5. In this case, it is not readily possible to bring the contact components 1, 2 into contact with each other and/or to bring the hold-down tool 9 in contract with the first, upper contact component 1. Rather, the contact components 1, 2 must be aligned with each other and/or placed flat against each other in order to ensure a zero gap and thus create a high-quality welded joint. To achieve this, the inventive hold-down tool 9 comprises a tubular hollow body 20, i.e., with a through-hole for the laser beam 7, and a tool insert 40 with the tool contact surface 53 held flexibly on the hollow body 20 in relation to the same.

In the following, three examples of the hold-down tool 9 are used to illustrate its possible design and function.

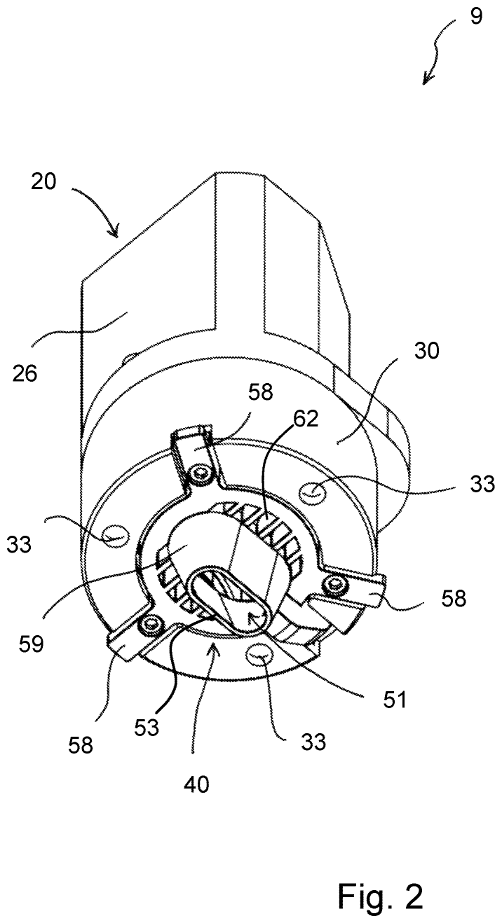

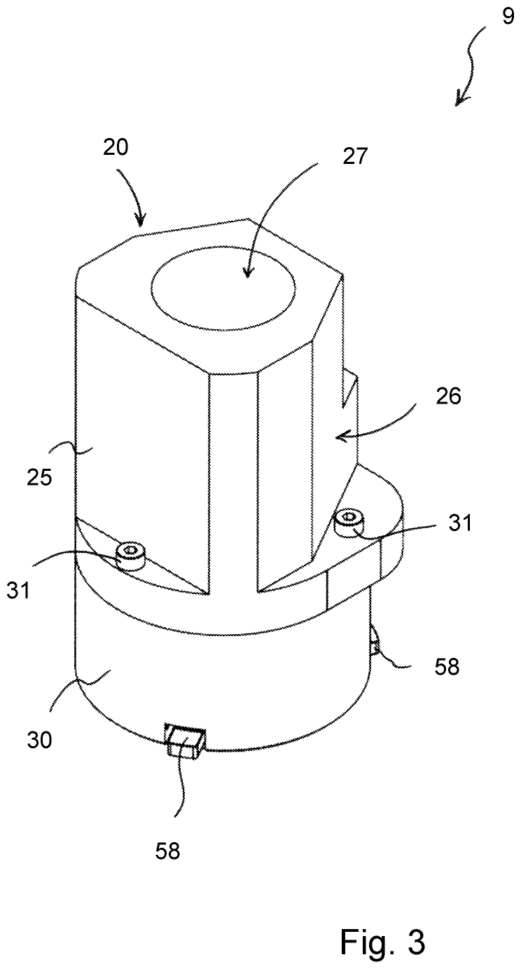

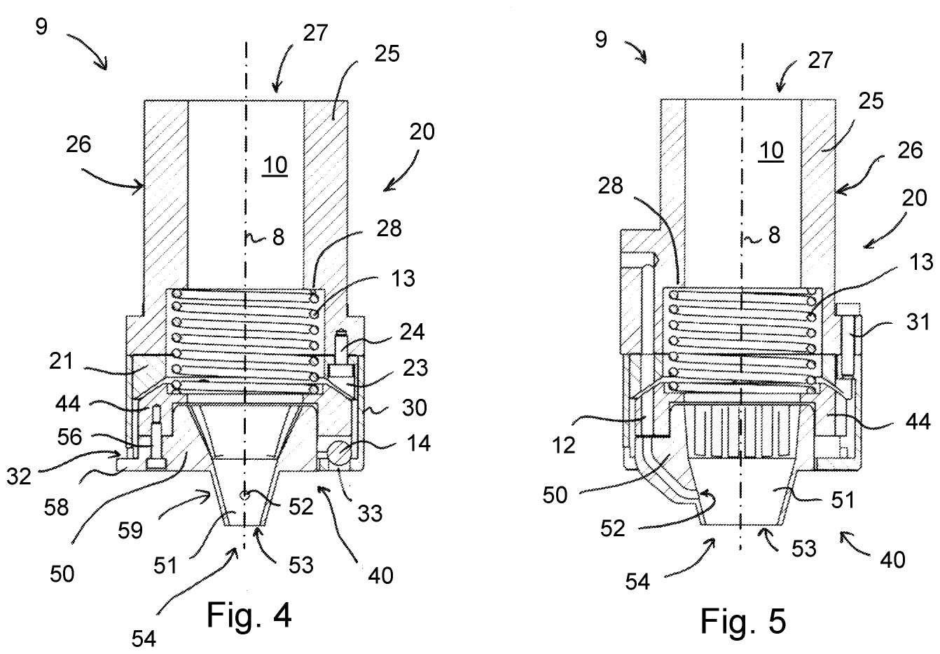

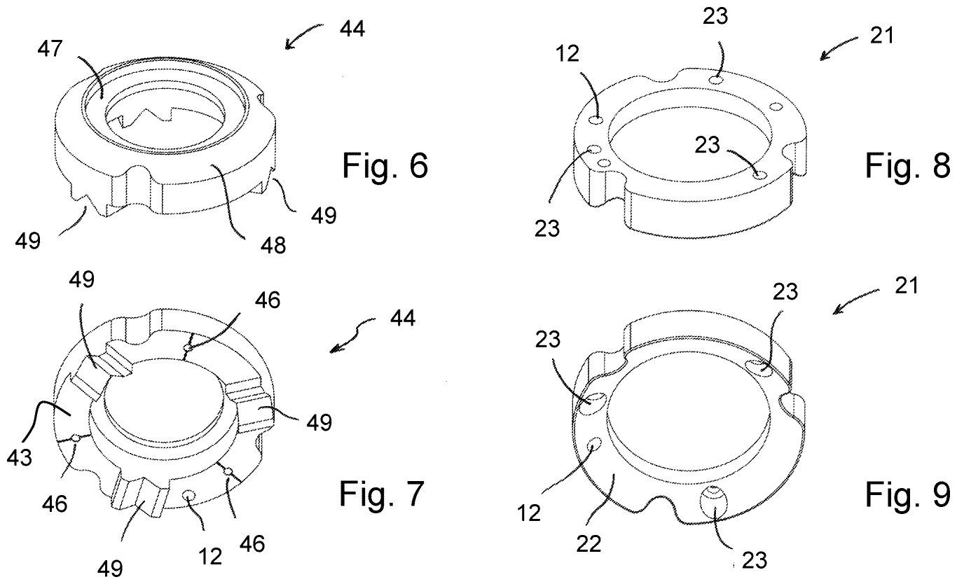

A first example of the hold-down tool 9 is shown in FIGS. 2 to 5. Accordingly, the hold-down tool 9 comprises the hollow body 20 with a lateral part 25, a base part 21 and a cap 30 as well as the tool insert 40 with an upper part 44 and an interchangeable body 50 as functionally essential components. The upper part 44 of the tool insert 40 is shown in detail in FIGS. 6 and 7. FIGS. 8 and 9 show the base part 21 of the hollow body 20.

The hollow body 20 provides the lateral part 25 with a lateral surface 26 closed on the lateral side. A part of the laser channel 10 extends through the lateral part 25 in the direction of the longitudinal center axis 8 of the hold-down tool 9.

The base part 21 is assigned to the lateral part 25 in the area of an end face facing the tool insert 40 or the first, upper contact component 1. The base part 21 provides a ball ring segment lateral-like base surface 22 to which the tool insert 40 can be attached. The base part 21 is fixed on the hollow body 20 by means of screws 24 that engage in through-holes 23 of the base part 21.

Furthermore, the cap 30 is attached to the lateral part 25 of the hollow body 20. The cap 30 encloses the base part 21 with the base surface 22. The cap 30 also encloses the tool insert 40 in sections. The cap 30 is fixed to the hollow body 20 using screws 31.

Like the hollow body 20, the tool insert 40 is designed in several parts. It includes the upper part 44 as well as the interchangeable body 50, which is fixed to the upper part 44 by means of screws 56. To accommodate the screws 56, the upper part 44 provides a total of three blind bores 46 distributed in a circumferential direction.

The upper part 44 provides a ball ring segment lateral surface 48 on an upper side facing the base part 21 of the hollow body 20, which is shaped in the form of a ball ring segment-like lateral surface corresponding to the base surface 22 of the base part 21. On a lower side opposite the upper side, three ball seats 49 are arranged in the direction of circumference on the upper part 44 of the tool insert 40. The ball seats 49 each have an essentially wedge-shaped groove protruding radially from the longitudinal center axis 8 of the hold-down tool 9. They serve to support the tool insert 40 against the cap 30 of the hollow body 20 via three bearing balls 14. The cap 30 has three through-holes 33 correspondingly opposite the ball seats 49 as a holder for the bearing balls 14.

The interchangeable body 50 is placed against an insert shoulder 43 of the upper part 44 of the tool insert 40 and thus assumes a fixed relative position to the upper part 44 of the tool insert 40. It provides a tapering attachment 59, which protrudes beyond the cap 30 of the hollow body 20. The attachment 59 of the interchangeable body 50 provides the tool contact surface 53. The tool contact surface 53 is flat or flat while surrounding the attachment 59 in a ring.

In order to fix the tool insert 40 to the hollow body 20 in a torsion-resistant manner, three arms 58 are formed on the tool insert 40, regularly spaced in the circumferential direction and protruding outwards. The arms 58 are guided with play through three recesses 32 formed on the lateral side of the cap 30 of the hollow body 20 in such a way that the tool insert 40 can be pivoted relative to the hollow body 20 or the cap 30.

The attachment of the tool insert 40 to the hollow body 20 is carried out in the direction of the longitudinal center axis 8 of the hold-down tool 9 by means of a pressure spring 13, which is surrounded on the outside by the lateral part 25, the base part 21 and the cap 30 of the hollow body 20 as an internal pressure spring 13. For one, the pressure spring 13 is pressed with two opposing end faces thereof against a shoulder 28, which is formed on the lateral part 25 of the hollow body 20. In addition, the pressure spring 13 is pressed against another shoulder 47, which is formed on the upper part 44 of the tool insert 40. The pressure spring 13 is dimensioned in such a way that the tool insert 40 is arranged in a non-attachment position of the hold-down tool 9 in the direction of the longitudinal center axis 8 as shown in FIGS. 2 to 5, spaced apart from the base part 21 of the hollow body 20 and at the same time supported against the cap 30 by means of the bearing balls 14, which engage in the through-holes 33 of the cap 30 and lean against the ball seats 49.

The laser channel 10, which runs in the direction of the longitudinal center axis 8 of the hold-down tool 9, is guided through the entire hollow body 20 with the lateral part 25, the base part 21 and the cap 30. The laser channel 10 is also guided through the tool insert 40 with the upper part 44 and the interchangeable body 50. The laser channel 10 provides a laser inlet opening 27 on the end face of the lateral part 25 of the hollow body 20 and a laser outlet opening 54 surrounded by the tool contact surface 53 in the area of the attachment 59. In the area of the attachment 59, the laser channel 10 also defines a working space 51. In the working space 51, the laser beam 7 hits the first, upper contact component 1.

In addition to the laser channel 10, the hold-down tool 9 includes a gas channel 12. The gas channel 12 is used to supply a gas as a purge gas to the working space 51. The working space 51 provides a gas outlet opening 52 as the end of the gas channel 12. The gas is recirculated by the laser channel 10 as an example. In particular, an extraction device may be provided for this purpose.

The extraction device may also be used to draw ambient air flowing into the inlet openings 62 provided on the tool insert 40 and through the laser channel 10.

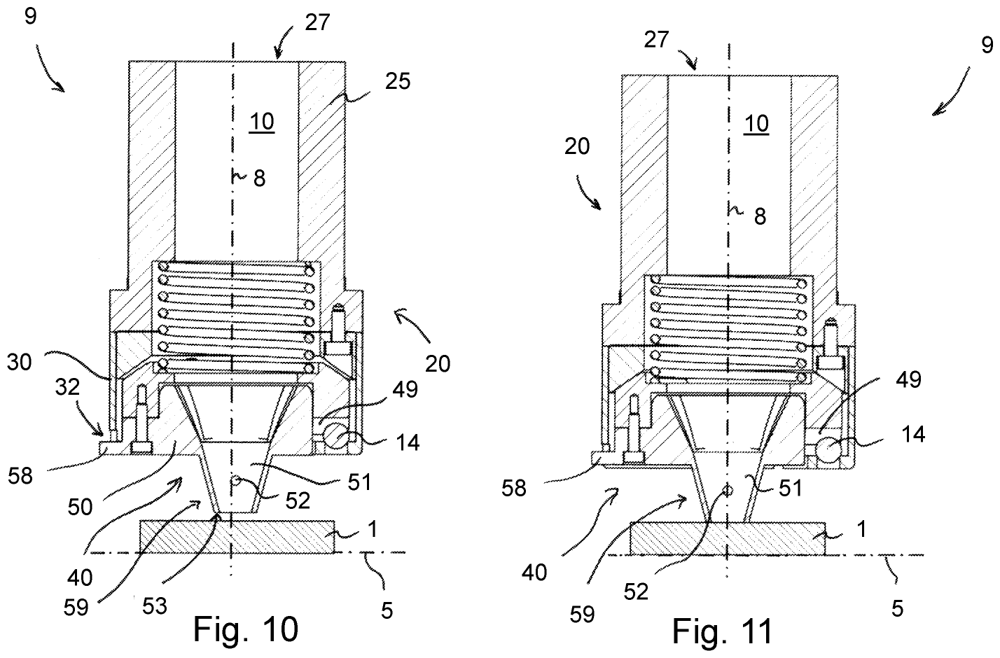

FIGS. 10 and 11 show the operation of the hold-down device 9 in the first example when it is placed on a flat surface of the first contact component 1 extending parallel to the working plane 5. The hold-down device 9, which is initially provided at a distance from the first contact component 1 in the non-attachment position, is lowered forward in the direction of the first contact component 1 with the attachment 59 of the tool insert 40. The longitudinal center axis 8 of the hold-down device 9 is oriented perpendicular to the working plane 5. As soon as the tool contact surface 53 of the tool insert 40 is in a flat contact with the surface of the first contact component 1 (contact position) and the hollow body 20 of the hold-down tool 9 is lowered further, the tool insert 40 compresses. The pressure spring 13 is compressed until the tool insert 40 with the ball ring segment lateral surface 48 is in contact with the base surface 22 of the base part 21 and a contact position has been reached. At the same time, the ball seats 49 detach from the bearing balls 14.

As soon as the hold-down device 9 has been moved from the non-contact position according to FIG. 10 to the contact position according to FIG. 11, the welding can begin. For this purpose, the gas can be supplied via the gas channel 12 and enter the working space 51 through the gas outlet opening 52. In addition, the laser source 3 is activated so that the laser beam 7 passes through the laser channel 10 and hits the first contact component 1. The latter is then melted by the energy of the laser beam 7 and cohesively connected to the second contact component 2.

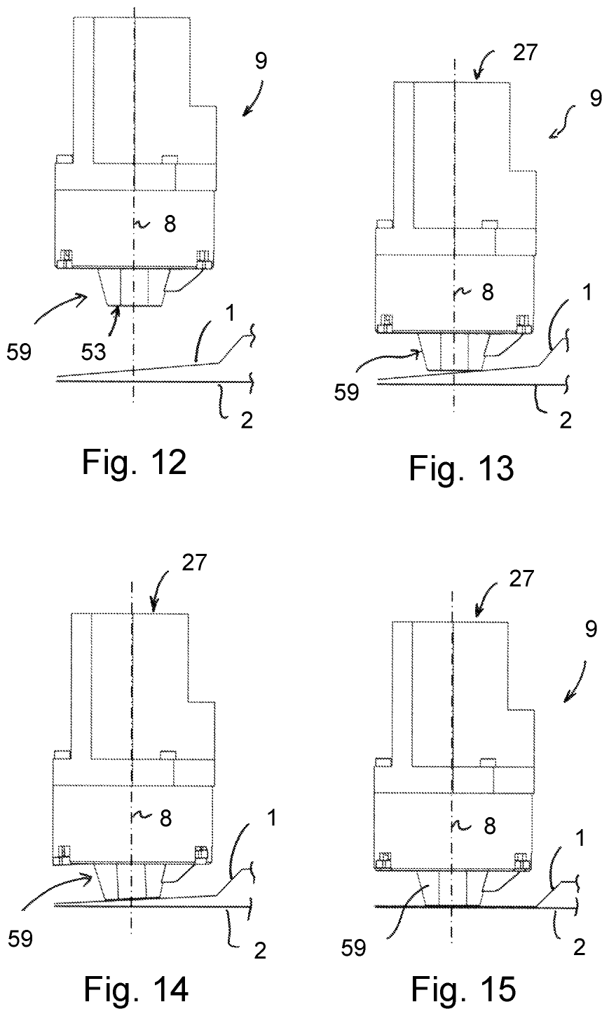

If the first contact component 1 does not lie flat against the second contact component 2 and the first contact component 1 does not extend perpendicular to the longitudinal center axis 8 of the hold-down device 9, a gap is formed between the first and the second contact component 1, 2. This initial situation is shown in FIG. 12. In order to weld them together safely and reliably despite the unfavorable arrangement of the contact components 1, 2, the hold-down tool 9 is lowered in the first step until contact is made with the first contact component 1 (see FIG. 13). Subsequently, as a result of the contact and the material stiffness of the first contact component 1, the tool insert 40, of which only the attachment 59 protrudes from the cap 30 and is visible in FIG. 14, is pivoted relative to the tool contact surface 8 in such a way that the tool insert 40 with the tool contact surface 53 is placed flat on the first contact component 1. From the time of the flat attachment of the tool contact surface 53 on the surface of the first contact components 1, they are in the contact position. Subsequently, in the course of further lowering, the first contact component 1 is pressed flat against the second contact component 2 with the help of the hold-down tool 9. In this process, the tool insert 40 pivots back and the flat contact of the contact components 1, 2 shown in FIG. 15 is formed. The welding can now be carried out as described above.

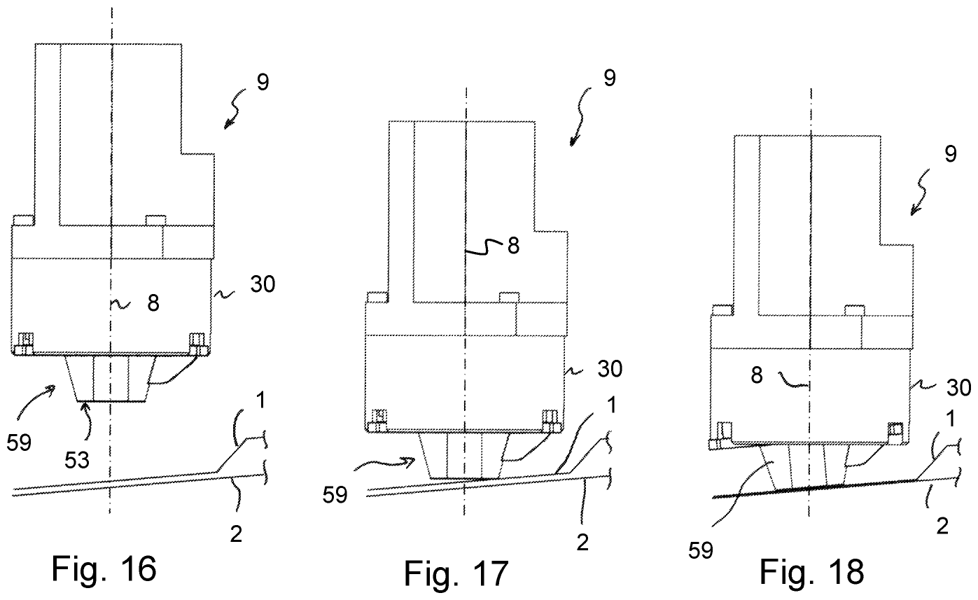

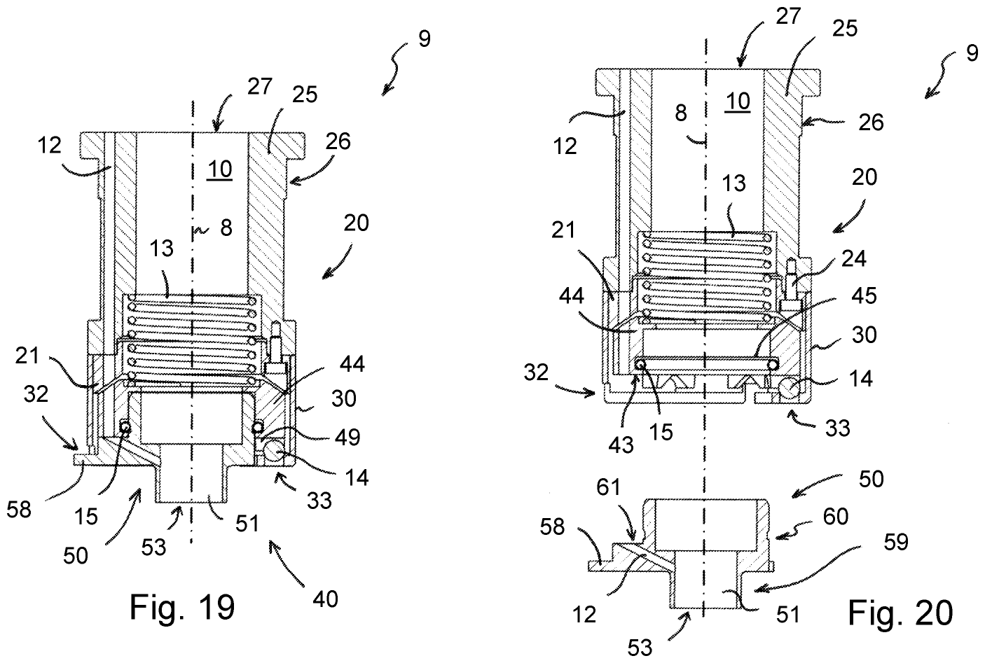

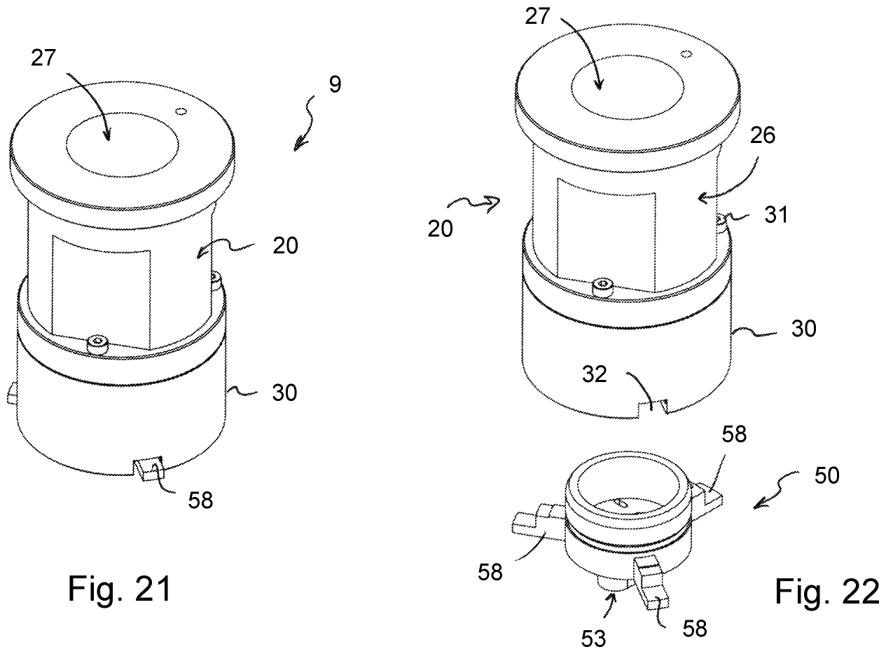

FIGS. 16 to 18 show an initial configuration for the laser welding in which the contact elements 1, 2 do not extend in the working plane 5 or are not oriented perpendicular to the longitudinal center axis 8 of the hold-down tool 9 and in which a gap is also formed between the contact components 1, 2. As usual, the hold-down tool 9 is lowered in a first step until a first contact is made between the attachment 59 of the tool insert 40 and the first contact component 1. Subsequently, the tool insert 40 pivots such that the tool contact surface 53 lies flat against the first contact component 1 and presses the first contact component 1 against the second contact component 2 until the gap between the contact components 1, 2 is closed. Welding can now take place in the inclined arrangement of the tool insert 40. The tool insert 40 is supported in the familiar manner with the ball ring segment lateral surface 48 against the base surface 22 of the base part 21. A maximum pivot angle is functionally necessarily tuned to a transverse dimension of the laser channel 10 in such a way that, despite the inclined position of the laser channel 10 tool insert 40, the laser beam 7 passes through the laser channel 10 and hits the first contact component 1 unhindered.

Whereas the interchangeable body 50 is screwed to the upper part 44 of the tool insert 40 according to the first example of the hold-down tool 9 and can therefore only be replaced with the help of tools, a second example of the hold-down tool 9 shown in FIGS. 19 to 22 shows a tool insert 40 in which an interchangeable body 50 is fixed to the upper part 44 of the tool insert 40 by means of a retaining spring 15 and can be changed without tools. The retaining spring 15 is elastic and deformable as a ring spring in the circumferential direction and in the radial direction, so that it is possible to insert the interchangeable body 50 into the upper part 44 by deforming the retaining spring 15. The retaining spring 15 engages in two circumferential retaining spring grooves 45, 60 formed correspondingly on the interchangeable body 50 and the upper part 44.

The tool-free replacement of the interchangeable body 50 makes it possible to quickly replace a worn and/or dirty interchangeable body 50 in production. The use of the hold-down tool 9 in the second example is thus optimized for high productivity and short downtimes.

The relative attachment of the interchangeable body 50 to the upper part 44 in the direction of the longitudinal center axis 8 is realized by an end face 61 formed on the interchangeable body 50 and a correspondingly formed insert shoulder 43 of the upper part 44.

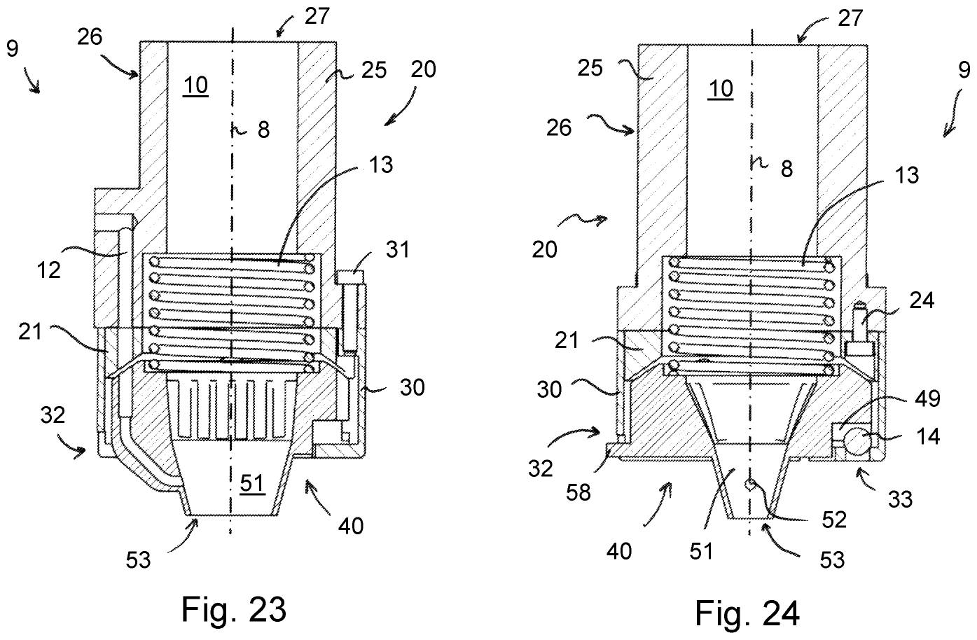

FIGS. 23 and 24 show a third example of the hold-down tool 9. Here, the tool insert 40 is formed in one piece. The one-piece tool insert 40 provides the attachment 59, part of the gas channel 12 and the ball ring segment lateral surface 48 and also provides the shoulder 47 against which the pressure spring 13 is applied. In this respect, it interprets the functions of the base part 21 and the interchangeable body 50 of the tool insert 40 of the hold-down tool 9 according to the first example.

Identical components and component functions are identified by the same reference signs.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A hold-down tool for a laser welding system, the hold-down tool comprising:
a tubular hollow body, which has a lateral surface that is designed to be in a laminar manner at least in sections; and
a tool insert formed as a contact element, the tool insert being flexibly held on the hollow body and provides a tool contact surface to bring the tool insert into contact with a first contact component to be welded.

2. The hold-down tool according to claim 1, wherein the tool insert is spring-mounted on the hollow body.

3. The hold-down tool according to claim 1, wherein the tool contact surface is ring-shaped and/or flat.

4. The hold-down tool according to claim 1, wherein the tool insert is designed as a hollow ball ring segment and/or hollow ball ring segment-like.

5. The hold-down tool according to claim 4, wherein the hollow ball ring segment-like tool insert has a ball ring segment lateral surface, wherein the hollow body provides a base surface corresponding to the ball ring segment lateral surface, to which the tool insert is adapted to be attached with the ball ring segment lateral surface, wherein the tool insert is arranged in a pivotable manner relative to the hollow body, and wherein the tool insert is pivoted about a pivot point formed on the surface of the first contact component in a contact position in which the tool contact surface of the tool insert is in flat contact with a surface of the first contact component.

6. The hold-down tool according to claim 1, wherein the tool insert is designed in several parts.

7. The hold-down tool according to claim 6, wherein the tool insert provides an interchangeable body held interchangeably on an mounting component of the tool insert, and wherein the interchangeable body provides the tool contact surface.

8. The hold-down tool according to claim 7, wherein the interchangeable body is fixed to the mounting component in a force-fit and/or form-fitting manner.

9. The hold-down tool according to claim 7, wherein the tool insert has an upper part, wherein the upper part serves as the mounting component and provides the ball ring segment lateral surface.

10. The hold-down tool according to claim 1, wherein the tool insert has an attachment protruding from the hollow body, and wherein the attachment provides the tool contact surface.

11. The hold-down tool according to claim 1, wherein the tool insert is supported against the hollow body by at least one bearing ball and/or wherein the tool insert and the hollow body each provide a number of ball seats and/or through-holes corresponding to the number of bearing balls.

12. The hold-down tool according to claim 2, further comprising a pressure spring for the spring-mounted support of the tool insert on the hollow body and/or wherein the pressure spring is realized as an internal pressure spring which is encircled by the hollow body and/or the tool insert.

13. The hold-down tool according to claim 1, wherein the hollow body is formed in several parts and/or wherein the hollow body has a base part, and the base part providing the base surface that is formed corresponding to the ball ring segment lateral surface.

14. The hold-down tool according to claim 13, wherein the hollow body has a lateral part providing the lateral surface and/or a cap and/or wherein the cap encloses the lateral part of the hollow body and/or the tool insert at least in sections.

15. The hold-down tool according to claim 1, wherein a gas channel is provided over which a gas is adapted to be supplied to a working space formed on the tool insert and/or wherein the gas channel extends through the hollow body and/or the tool insert.

16. The hold-down tool according to claim 1, wherein a laser channel is provided through which a laser beam is adapted to be guided to the contact component to be welded, and/or wherein the laser channel extends through the hollow body and/or the tool insert.

17. The hold-down tool according to claim 1, wherein the tool insert and/or the interchangeable body of the tool insert and/or the hollow body is made of an electrically insulating material or of technical ceramics, at least in an area comprising the tool contact surface.
